(19) United States
(12) Patent Application Publication
(10) Pub. No.: US 2009/0021486 A1
(43) Pub. Date: Jan. 22, 2009

(54) Dashboard Surfaces

(75) Inventors: Imran A. Chaudhri, San Francisco, CA (US); John O. Louch, San Luis Obispo, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/867,642

(22) Filed: Oct. 4, 2007

Related U.S. Application Data
(60) Provisional application No. 60/950,735, filed on Jul. 19, 2007.

(51) Int. Cl. G06F 3/041; G06T 1/00

(52) U.S. Cl. 345/173; 345/522

(57) ABSTRACT

Information can be displayed on a variety of dashboard surfaces. In some implementations, the technology for displaying information on a dashboard surface can be different, depending on the environment and/or intended use of the dashboard surface. In some implementations, the visualization may be different as well. In some implementations, each type of dashboard surface provides its own metadata or information, which can be used to configure or reconfigure the dashboard surface for interaction with one or more users.

### RELATED APPLICATIONS

This application claims priority to U.S. Provisional Patent Application Ser. No. 60/950,735 filed Jul. 19, 2007, and entitled “Dashboard Surfaces,” the contents of which are incorporated herein by reference.

### TECHNICAL FIELD

The subject matter of this patent application is generally related to graphical user interfaces.

### BACKGROUND

A hallmark of modern graphical user interfaces is that they allow a large number of graphical objects or items to be displayed on a display screen at the same time. Leading personal computer operating systems, such as Apple Mac OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

Although users appreciate interfaces that can present information on a screen via multiple windows, the result can be overwhelming. For example, users may find it difficult to navigate to a particular user interface element or to locate a desired element among a large number of onscreen elements. The problem is further compounded when user interfaces allow users to position elements in a desired arrangement, including overlapping, minimizing, maximizing, and the like. Although such flexibility may be useful to the user, it can result in a cluttered display screen. Having too many elements displayed on the screen can lead to “information overload,” thus inhibiting the user to efficiently use the computer equipment.

Many of the deficiencies of conventional user interfaces can be reduced using “widgets.” Generally, widgets are user interface elements that include information and one or more tools that let the user perform common tasks and provide fast access to information. Widgets can perform a variety of tasks, including without limitation, communicating with a remote server to provide information to the user (e.g., weather report), providing commonly needed functionality (e.g., a calculator), or acting as an information repository (e.g., a notebook). Widgets can be displayed and accessed through an environment referred to as a “unified interest layer,” “dashboard layer,” “dashboard environment,” or “dashboard.”

Dashboards are typically presented on displays of devices, such as computers, mobile phones, media players/recorders, game consoles, tablets, set-top boxes, etc. The presentation of dashboards, however, need not be limited to presentations on displays of devices.

### SUMMARY

Information can be displayed on a variety of dashboard surfaces. In some implementations, the technology for displaying information on a dashboard surface can be different, depending on the environment and/or intended use of the dashboard surface. In some implementations, the visualization may be different as well. In some implementations, each type of dashboard surface provides its own metadata or information, which can be used to configure or reconfigure the dashboard surface for interaction with one or more users.

Other implementations of dashboard surfaces are disclosed, including implementations directed to systems, methods, apparatuses, computer-readable mediums and user interfaces.

### DESCRIPTION OF DRAWINGS

FIGS. 1A-1D illustrate various implementations of dashboard surfaces.

FIG. 2 is a block diagram of an implementation of a dashboard surface system.

FIG. 3 is a block diagram of an implementation of a dashboard administrative service.

FIG. 4 is flow diagram of an implementation of a dashboard surface generation process.

FIG. 5 is a block diagram of an implementation of a runtime architecture for a dashboard surface manager.

### DETAILED DESCRIPTION

### Dashboard & Widget Overview

A dashboard is an environment or layer where information and utilities can be displayed. The information and utilities can be embodied in “widgets.” Multiple widgets can exist in a dashboard at any given time. Users can control what widgets are visible and can freely move the widgets in the dashboard. In some implementations, widgets can be displayed and hidden along with the dashboard and can share the dashboard. When the dashboard is dismissed, the widgets disappear along with the dashboard.

In some implementations, widgets are objects that users interact with when a dashboard is invoked. In other implementations, widgets can be displayed in any user interface without a dashboard, including an operating system window (e.g., a desktop) or application window, or one or more display areas (or portions thereof) of a user interface. Widgets can perform tasks for the user, such as providing a clock or a calculator. A widget can present useful information to the user or help the user obtain information with a minimum of required input. In some implementations, widgets are powered by known web technologies, such as Hypertext Mark-up Language (HTML), Cascading Style Sheets (CSS) and JavaScript®. Some widgets can also provide preferences, localization and system access. In the description and examples that follow, a user interacts with representations of dashboards and widgets, such as icons or thumbnail images. These representations may be referred to simply as dashboards or widgets throughout the specification and claims.

In some implementations, a dashboard is displayed such that a user can select a widget, causing the widget to be displayed without a dashboard (e.g., on a desktop user interface or application window). In such implementations, the user can click on a button or other user interface element to get back the dashboard.

Widgets can be developed using publicly available software development tools, such as Web Kit, Dashcode® and Xcode®, which are available from Apple Computer, Inc. (Cupertino, Calif.). Web Kit provides a set of classes to display web content in windows, and implements browser features such as following links when clicked by the user, managing a back-forward list, and managing a history of pages recently visited. The Web Kit simplifies the process of web page loading by asynchronously requesting web content from an HTTP server where the response may arrive incrementally, in random order, or partially due to network errors. The Web Kit also simplifies the process of displaying that content and compound frame elements each with their own set of scroll bars. Dashcode® provides developers with tools for building widgets. Xcode® is a tool for developing software on Mac OS® X, and is bundled with Apple's Mac OS® X, version 10.4 (“Tiger”) operating system.

In some implementations, a widget can be distributed as a bundle structure. A bundle is a directory in a file system that groups related resources together in one location. A widget's bundle can contain an information property list file, an HTML file, icon and default image files (e.g., portable network graphics files) and a style information file (e.g., a CSS file). In some implementations, the information property list file provides a dashboard with information about a widget (e.g., name, version, widget height and width, x and y coordinates for placement of the widget close box, etc.). The dashboard can use the information property list file to set up a space or “view” in the dashboard in which the widget can operate. The information property list file can also include access keys which provide access to external resources (e.g., the Internet).

In some implementations, dashboards and widgets interact with an application programming interface (API). A dashboard or widget can be installed on a device and configured to communicate with the device through the API. In some implementations, a dashboard or widget can introspect the environment of a device using the API, and then configure itself to work on the device using information obtained through the API. In some implementations, a dashboard or widget can provide information to the device through the API, allowing the device to configure itself to work with the dashboard or widget.

In some implementations, the API specifies a “presentation mode” that describes the display capability of a device. For example, a dashboard or widget can learn the “presentation mode” of a device and configure itself to comply with the mode. In some implementations, the “presentation mode” could include a “large display” configuration, a “medium display” configuration and a “small display” configuration, which correspond to the display size of the device. For example, in a “small display” configuration, the dashboard or widget can scale icons and images to fit the small display.

In some implementations, the API specifies an “input capability” that describes the input controls available on a device. A dashboard or widget can learn of the input capabilities of a device through the API and configure itself to work with those capabilities. For example, if a device includes a scroll wheel, a widget can configure itself to allow scrolling that is optimized for a scroll wheel.

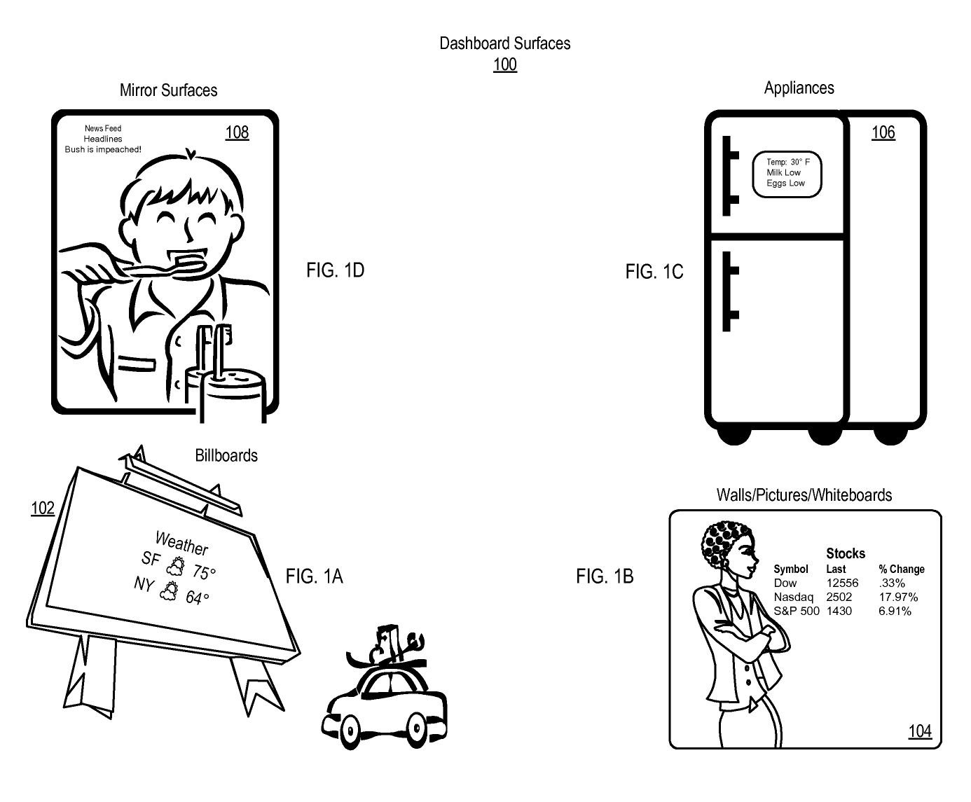

In some implementations, dashboards and widgets interact with a dashboard surface through an API, as described in reference to FIG. 1. A dashboard and/or widget can be presented on a dashboard surface and configured to communicate with the dashboard surface through the API. In some implementations, a dashboard and/or widget can introspect the dashboard surface using the API, and adopt a configuration that is conforms to any requirements or limitations of the dashboard surface. In some implementations, a dashboard or widget can provide information to the dashboard surface through the API, allowing the dashboard surface to configure itself to work with the dashboard or widget.

### Dashboard Surfaces

A dashboard surface can be any surface capable of presenting information. In some implementations, the dashboard surface can be an application that runs mini-applications or widgets. A dashboard surface need not be a display of a device, such as, for example, a computer, mobile phone, etc. Rather, any surface can be a dashboard surface, including billboards, walls, pictures, whiteboards, appliances, mirrors, holograms, electronic paper, etc. In some implementations, the dashboard surface presents a dashboard or dashboard layer. In other implementations, the dashboard surface is the dashboard or dashboard layer.

Dashboard surfaces can respond to input data from the environment and users. Input data can include but is not limited to: touch or multitouch input data, biometric data (e.g., fingerprints, retinal scans), facial feature recognition data, voice recognition data, motion or sound detection data, proximity sensor data, etc. For example, a dashboard can use input data to recognize its environment and/or a particular user, and to configure or reconfigure itself to operate in the environment and/or to interact with the user.

In some implementations, a dashboard surface can be operatively coupled to a processor and memory or storage media that includes software, firmware, scripts or other instructions for generating and managing the dashboard surface. Hereinafter, such as system is referred to as a “dashboard surface system.” Managing a dashboard surface can include processing input (if available) and generating audio or visual content (e.g., graphic objects, icons, text, music, video, photos) for presentation on the dashboard surface. In some implementations, the presentation of the content and other information can be provided through one or more widgets.

FIGS. 1A-1D illustrate various implementations of dashboard surfaces 100. Referring to FIG. 1A, in some implementations a dashboard surface 102 can be any wireless electronic digital signage capable of presenting images and other information. Electronic digital signage can include but is not limited to: LCD panels, LED panels, projection screens, plasma panels, LED billboards, LED video displays, etc. In the example shown, the dashboard surface 102 is a billboard which can be used to present, for example, current weather information.

In some implementations, the dashboard surface 102 can include sensors (e.g., temperature sensors) for measuring, for example, environment conditions and displaying content based on the measurement. For example, if the environment temperature is below a certain threshold value, the dashboard surface 102 can display advertisements associated with hot beverages, winter clothing, vacations to Florida, etc. The dashboard surface 102 could also take on a theme by changing its color or adding embellishments related to the current environment conditions (e.g., changing color tones to blue for cold temperatures and red for hot temperatures).

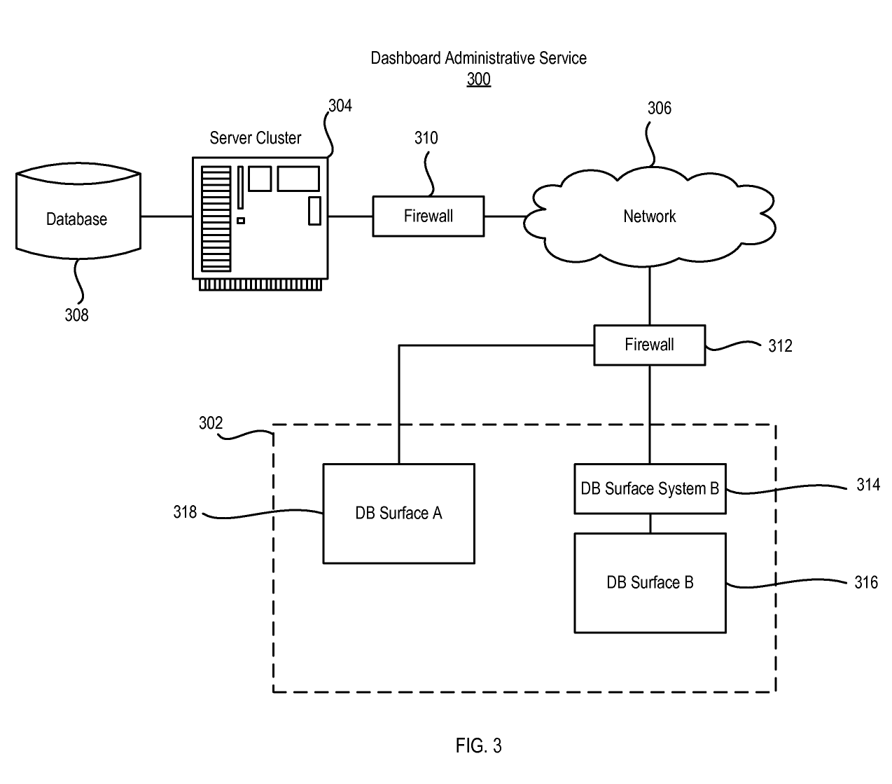

In some implementations, the dashboard surface 102 is operatively coupled to a network for receiving content from a server or other network device, as described in reference to FIG. 3. For example, the dashboard surface 102 could display the scores of a sporting event, which is received from, for example, a Really Simple Syndication (RSS) feed over a network connection (e.g., the Internet, a wireless network).

Referring to FIG. 1B, in some implementations a dashboard surface 104 can be an electronic video wall display, a digital picture frame or a smart whiteboard, which is capable of presenting images and other information. In the example shown, stock information is displayed on the dashboard surface 104. In some implementations, the dashboard surface 104 can be, for example, a SMART™ Board interactive whiteboard, developed by SMART Technologies, Inc. (Calgary, Canada). The SMART™ Board is a touch-sensitive display which can be connected to a computer and digital projector to show a computer image on the dashboard surface 104. The touch display senses a user's touch input and a computer coupled to the display performs one or more tasks based on the touch input.

Referring to FIG. 1C, in some implementations a dashboard surface 106 can be a surface (or a portion thereof) of a consumer electronic device or appliance, including but not limited to: refrigerators, ovens, stove tops, microwaves, televisions, stereos, washing machines and dryers, dishwashers, etc. In the example shown, a freezer door is the dashboard surface 104, which can include, for example, an embedded LCD panel for presenting content and other information. Alternatively, the dashboard surface 104 can have a magnetic backing (e.g., a refrigerator magnet) or other adhesive capability (e.g., Velcro®) for affixing the dashboard surface 104 to a consumer electronic device or appliance. Metadata or information can be provided by the electronic device or appliance and used to determine how the dashboard surface 106 will be presented on the device or appliance.

In some implementations, information related to the purpose of the device or appliance can be presented on the dashboard surface 106. For example, the current temperature inside the refrigerator can be displayed on the dashboard surface 106, together with an input mechanism (e.g., touch or multi-touch input) for allowing a user to adjust the temperature. Information regarding inventory can also be presented on the dashboard surface 106. For example, a drop in inventory for a stocked item (e.g., no milk or eggs) can be detected and presented on the dashboard surface 106 to remind the user to stop by the store. In some implementations, the refrigerator inventory can be detected using radio frequency identification (RFID) technology. RFID tags or smart labels can be applied to items stored in the refrigerator. An RFID scanner built into the refrigerator can detect when an item is removed from the refrigerator and decrement an inventory counter in response to the detection. The RFID scanner can be coupled to the dashboard surface 106 and provide the inventory information to the dashboard surface 106 for display.

Another example of a widget for use in, for example, a kitchen, is a recipe widget. The recipe widget could provide cooking instructions and act as a timer for cooking steps (e.g., stir for 10 minutes).

Referring to FIG. 1D, in some implementations a dashboard surface 108 can be a mirror or glass surface. In the example shown, while brushing his teeth a user watches a news feed projected on the dashboard surface 108. In some implementations, the dashboard surface 108 can be implemented using, for example, Miragraphy™ technology developed by Hitachi, Ltd, or Mirror TV™ technology developed by Philips Electronics, N.V. Miragraphy™ is an RFID-enabled mirror which combines a half mirror and a diffusion film to directly display digital information (e.g., text, photos, video, TV shows, websites, flash movies) on a mirror surface using an LCD projector. Mirror TV™ is an LCD display integrated into a mirror, which allows users to surf TV channels or the Internet while viewing their reflection.

In some implementations, the mirror is also touch sensitive and can receive touch input from the user, which can be used to, for example, search for and retrieve information (e.g., search the Internet or a local repository) for information or perform some other tasks or utilities. In some implementations, biometric technology (e.g., facial recognition technology) can be integrated with the mirror and used to configure a display of information based on a positive match with, for example, a user profile.

The dashboards surfaces described above are examples and other dashboard surfaces are possible. For example, a three-dimensional (3D) holograph can be a dashboard surface for providing 3D holographic images, which can be animated. For example, in some implementations, animated 3D holographic images or widgets can be created from digital media and presented on, for example, a touch sensitive surface for receiving touch input. An example of a suitable 3D holographic technology is the 3D holography technology developed by XYZ Imaging, Inc. (Montreal, Quebec).

Dashboard surfaces can also be integrated into a variety of household items and building materials, including but not limited to: floors, tiles, furniture, cabinets, marble countertops, mailboxes, window treatments, bathroom fixtures, lighting, etc.

### Dashboard Surface System

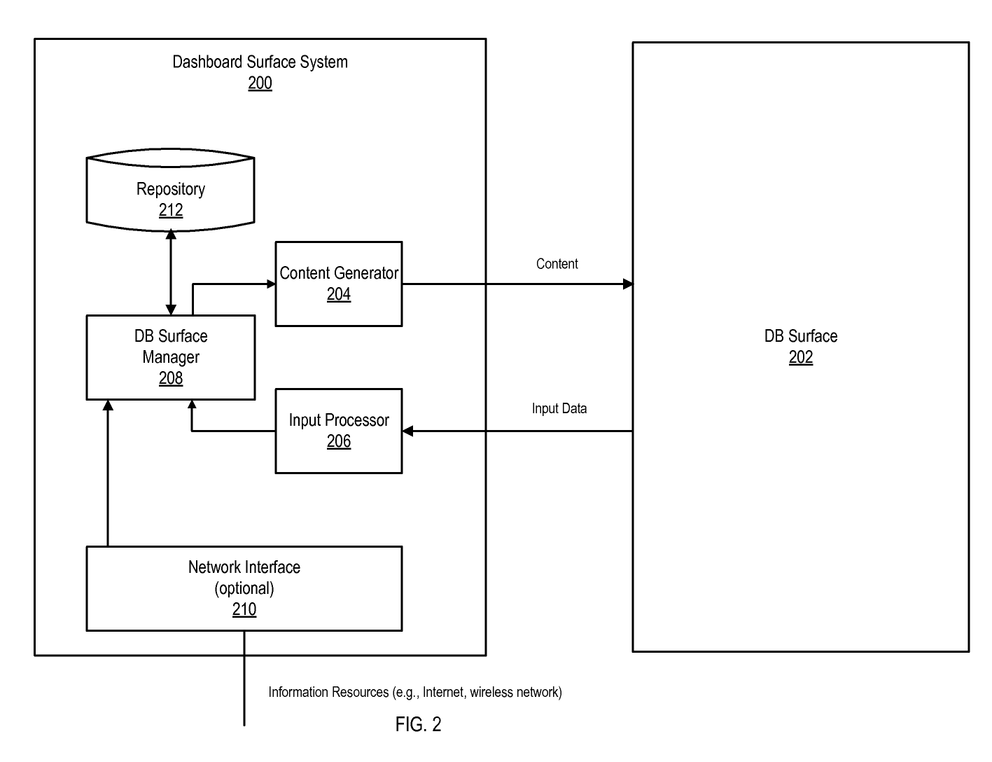

FIG. 2 is a block diagram of an implementation of a dashboard surface system 200. In some implementations, the system 200 includes one ore more content generators 204, one or more input processors 206, a DB surface manager 208, an optional network interface 210 and a repository 212. The dashboard surface system 200 can be integrated with the DB surface 202, directly coupled to the dashboard surface 202 and/or located on a network and coupled to the dashboard surface 202 through the network interface 210 (e.g., Internet, Ethernet, wireless network), as described in reference to FIG. 3. In some implementations, the components of the dashboard surface system 200 can be distributed over a network, where some components are integrated with, or directly coupled to, the system 200, and other components are located on the network.

In some implementations, the content generator 204 (e.g., a media playback appliance) provides content (e.g., graphics, text, videos, photos) for display on the DB surface 202. The content can be presented using widgets and/or presented directly on the dashboard surface 202. The content generator 204 can be controlled by, for example, the DB manager 208, which is coupled to the input processor 206 for receiving input data from the dashboard surface 202. Input can be generated by a variety of input devices including touch input, multi-touch input, virtual user interface elements (e.g., virtual buttons, dials, switches, keyboards, click-wheels), hardware input mechanism, network connections, radio frequency transceivers, image recognition, biometrics, etc.

In some implementations, the input processor 206 is operationally coupled to the DB manager 208 and includes software and/ or hardware components for translating and formatting input received by the dashboard surface 202 into a form that can be understood by the DB manager 208. In some implementations, the input data can be stored in the repository 212.

### Dashboard Administrative Surface

FIG. 3 is a block diagram of an implementation of a dashboard administrative service 300. In some implementations, a dashboard surfaces can be remotely managed over a network to allow for content updates, reporting or any other administrative task. For example, the service 300 can be used to monitor content playback, perform real time adjustments and provide live content feeds.

In some implementations, the service 300 includes a server cluster 304 coupled to a network 306 and a database 308 (e.g., MySQL®). The service 300 can include other components, such as routers, hubs, administrative computers, etc. In the example shown, the service 300 is operatively coupled to an environment 302 through the network 306 and firewalls 310 and 312.

In some implementations, an environment (e.g., a home, office, public space) can include one or more dashboard surfaces. The dashboard surfaces can be coupled to a network through a dashboard surface system or directly coupled to a network. In the latter configuration, a dashboard surface system can be integrated with the dashboard surface. In the example shown, an environment 302 includes a dashboard surface 318 coupled to a network 306 though a firewall 312, and a dashboard surface 316 coupled to the network 306 through a dashboard surface system 314 and the firewall 312.

In some implementations, the dashboard surface 318 is managed directly by the service 300. For example, content stored in the database 308 can be provided to the dashboard surface 318 for presentation through, for example, widgets. The content can be received and processed by a dashboard surface system integrated with the dashboard surface 318, or the content can be formatted for presentation on the dashboard surface 318 by the service 300. The latter configuration allows the dashboard surface 318 to display the content without additional processing, which means fewer components and a potentially cheaper design than, for example, the dashboard surface 316.

In some implementations, the dashboard surface 316 can be managed by the dashboard surface system 314, as described in reference to FIG. 2. In this configuration, the dashboard surface system 314 can communicate with the service 300 to receive from the service 300 content, widgets, dashboards, RSS feeds, software updates, administrative commands and any other information for use in managing the display surface 316.

The service 300 described above is one example of a possible configuration; other configurations are possible, including configurations with more or fewer components than is shown in FIG. 3.

### Home Network Example

In some implementations, and in particular a home network, a number of dashboard surfaces can be interconnected and share information. For example, a living room of a user's home may have a widget built into a coffee table surface. The user can invoke the dashboard surface using a variety of means, such as touching the surface, being in the proximity of the dashboard surface, voice commands, remote control, sound or motion detection, biometrics, etc. The user can interact with the dashboard surface or with one or more widgets presented on the dashboard surface. The user can input and receive information to and from the dashboard surface or widgets, and such information can be stored in a central repository in the user's home (e.g., on a personal computer hard drive).

Continuing with the example above, the user may leave the living room and enter the kitchen. The kitchen can contain a variety of dashboard surfaces associated with a variety of appliances (e.g., refrigerator, stove top, microwave). When the user enters the kitchen, the user's presence can be detected by sensors (e.g., motion sensor, proximity sensor, video camera), which then alert the dashboard surfaces in the kitchen of the user's presence. The dashboard surfaces can then configure or reconfigure themselves to interact with the particular user. For example, a dashboard surface on a refrigerator may reconfigure itself to present a custom information display for the user, such as providing news and other information that is of interest to the user. Such a system allows for a multi-user environment, where each family member has their own personal profile, which can be used to configure or reconfigure dashboard surfaces and/or widgets to conform to the user's personal profile. In some implementations, the personal profile can be created by the user on, for example, a personal computer coupled to the home network. The dashboard surfaces and/or widgets can communicate with each other using a protocol that can provide arbitration between the various dashboard surfaces.

In some implementations, the system 314 includes a protocol for arbitrating between different users who attempt to interact with the same dashboard surface at the same time. For example, two or more users may enter a room with a dashboard surface. The dashboard surface can configure or reconfigure itself to interact with one or more users. In some implementations, the arbitration protocol can enforce an order of access to the dashboard surface based on the order of user detection by the dashboard surface. For example, the first user detected by the dashboard surface can control the dashboard surface.

The protocol can be set by the system 314 or user (e.g., an administrator user). Users can be granted different access privileges for accessing dashboard surfaces or information presented by dashboard surfaces. The protocol can be part of an API, such as the API previously described with respect to dashboards and widgets.

### Dashboard Generation Process

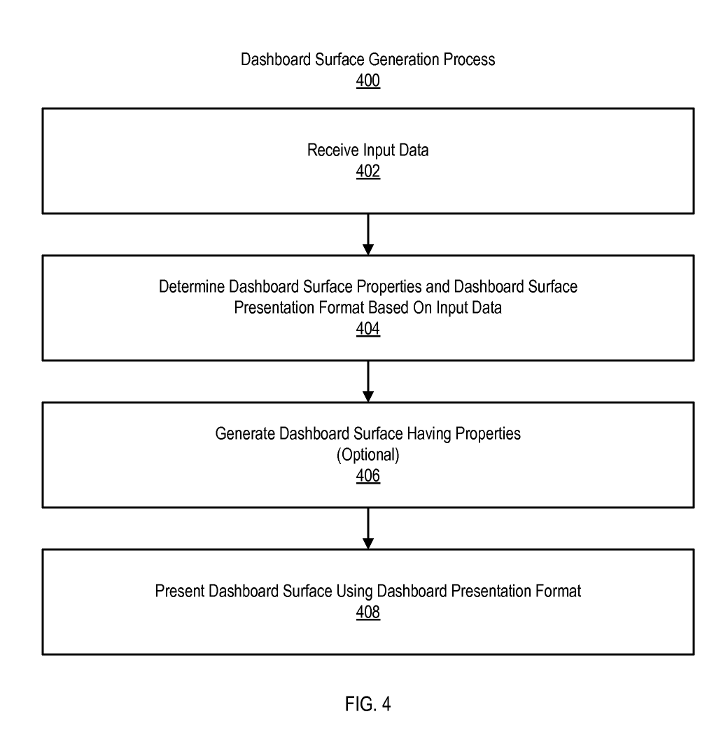

FIG. 4 is flow diagram of an implementation of a dashboard generation process 400. In some implementations, the process 400 begins when, for example, a dashboard surface system, receives input from a dashboard surface or other source (402). The input data can be metadata or other information associated with the dashboard surface or operating environment, such as configuration data (e.g., display area, features, input devices). The input can also be sensed information provided by sensors. For example, the dashboard surface can be touch sensitive or can include a temperature sensor, etc. In some implementations, the dashboard surface can include integrated positioning technology, such as, for example, a Global Positioning System (GPS) receiver, which can be used to determine the geographic location of the dashboard surface. In some implementations, the dashboard surface can be coupled to a network and receive content, widgets, dashboards, administrative commands and other information from various network resources, such as the service 300 described in reference to FIG. 3.

The dashboard system or dashboard surface (depending on the configuration) determines dashboard surface properties and a dashboard surface presentation format based on the input data (404). Optionally, a dashboard layer is generated having the properties for presentation on a dashboard surface (406). In some implementations, however, the dashboard surface is the dashboard. In such implementations, the dashboard surface is presented on mirrors, furniture, whiteboards, appliances, billboards and other materials or objects, using the dashboard presentation format (408).

The dashboard surface properties can include features and functionality that is made available through the dashboard surface. For example, the properties can determine the number and kinds of widgets that will be displayed and what those widgets can and cannot do. The presentation format includes, for example, the dimensions of the dashboard surface, dashboard themes, fonts, color schemes and any other information that can be used to determine how a dashboard will presented on the dashboard surface.

### Device Architecture For Dashboard Surface System

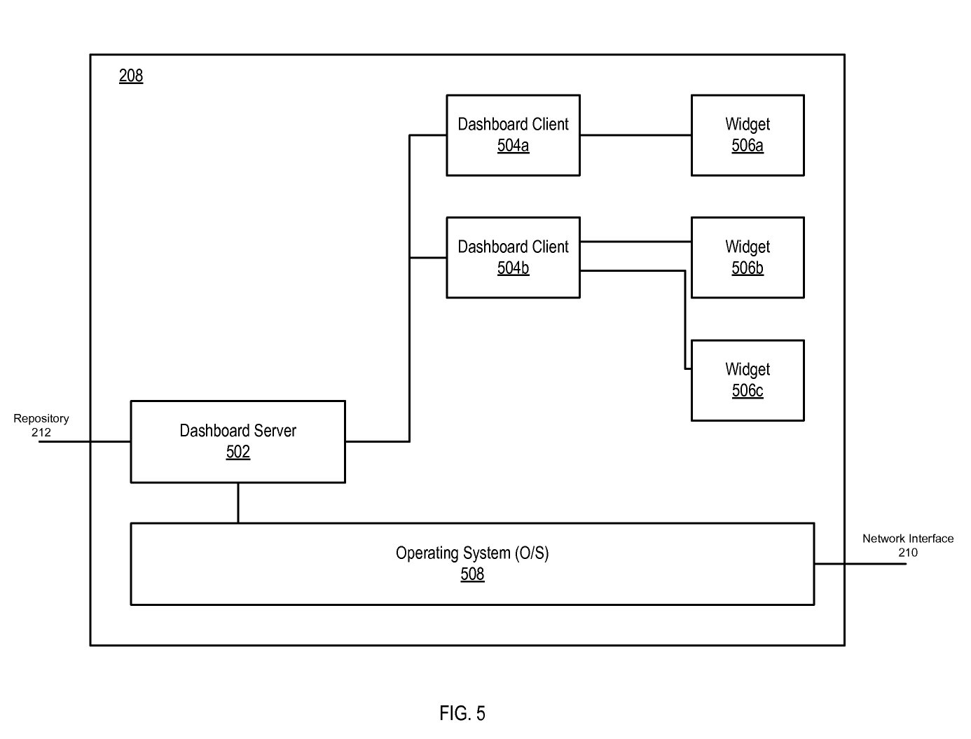

FIG. 5 is a block diagram of an implementation of an runtime architecture for a dashboard surface manager, such as the dashboard surface manager 208 described in reference to FIG. 2. In some implementations, the architecture generally includes a dashboard server 502, dashboard clients 504, widgets 506 and an operating system 508 (e.g., Mac OS® X, Windows® XP, Linux® OS). In some implementations, the dashboard server 502 is coupled to a repository for storing configuration and other information (e.g., repository 212 of FIG. 2). In some implementations, the dashboard server 502 can also be coupled to one or more interfaces (e.g., network interface 210 of FIG. 2). Information can be received through the network interface 210 and stored in the repository 212. The dashboard server 502 can use the information to configure one or more dashboards and/or widgets for presentation on a dashboard surface, such as the dashboard surfaces described in reference to FIG. 1.

In some implementations, the dashboard server 502 is a process that manages a dashboard surface and widgets 506. In some implementations, the dashboard clients 504 are processes that provide the glue between the dashboard server 502 and individual widgets 506. In some implementations, each widget 506 is run inside a separate dashboard client 504. In other implementations, multiple widgets (e.g., widgets 506b, 506c) can run inside a dashboard client 504 (e.g., dashboard client 504b). For example, the dashboard clients 504 can provide views in the dashboard for displaying a user interface. In the example shown, the dashboard server 502 launches one client 504 per running widget 506, which provides a sandbox so that the widget 506 does not affect other widgets or applications. If a widget 506 crashes, the widget 506 can be automatically restarted so that the widget reappears in the dashboard. If a widget 506 misbehaves (e.g., crashing more than x times in a row), the widget 506 can be automatically removed from the dashboard.

Widgets 506 can be displayed on dashboard surface created by the dashboard server 502 or in other user interfaces, such as a desktop or in a browser or application window (e.g., Safari®). In some implementations, a widget 506 can be stored as a “bundle” of files in the repository 210 (e.g., hard disk, RAM, ROM, flash memory). A bundle is a directory that groups all the needed resources for the widgets 506 together in one place. Widget bundles can be named with a unique extension (e.g., .wdgt).

In some implementations, a given widget contains at least the following files: 1) an HTML file defining a user interface for the widget; 2) a default background image that can be displayed by the dashboard while it loads the widget; 3) an icon image used to represent the widget; and 4) a property list file that contains the widget's identifier, name, version information, size, and main HTML page and other optional information used by the dashboard. The bundle can include other files as needed for the widget, include but not limited to CSS files and JavaScript® files.

In some implementations, a scripting language (e.g., JavaScript®) can be used to provide dynamic behavior in widgets. A script can be distinguished from a program, because programs are converted permanently into binary executable files (i.e., zeros and ones) before they are run. By contrast, scripts remain in their original form and are interpreted command-by-command each time they are run.

JavaScript® in a dashboard can work the same way as it does in any browser with the addition of a widget object. The widget object allows the following actions: 1) access to a user preferences system; 2) flipping a widget over to access preferences or other information and links; 3) respond to dashboard activation events; 4) open other applications; and 5) execute system commands, such as shell scripts or command-line tools.

For widgets built using Web Kit, any Internet plug-in can be run from within the widget. For example, a widget could display a movie using a QuickTime® Internet plug-in. In some implementations, widgets can interact with an application by loading a plug-in and using, for example, a JavaScript® object to bridge JavaScript® with an application programming language (e.g., Objective-C).

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The basic elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications may be made to the disclosed implementations and still be within the scope of the following claims.

What is claimed is:

1. A method, comprising:
receiving information from or through a dashboard surface; and
configuring or reconfiguring the dashboard surface for interaction with one or more users based on the information.

2. The method of claim 1, further comprising:
presenting a widget on the dashboard surface; and
presenting content through the widget.

3. The method of claim 1, further comprising:
receiving environment information associated with the environment where the dashboard surface is located; and
configuring or reconfiguring the dashboard surface based on the environment information.

4. The method of claim 1, further comprising:
receiving user input; and
configuring or reconfiguring the dashboard surface based on the user input.

5. The method of claim 1, wherein the dashboard surface is from a group of dashboard surfaces consisting of: a billboard, a sign, a wall, a whiteboard, a picture frame, a glass surface, a mirror surface, one or more liquid crystal display panels, one or more light emitting diode panels, a surface on an appliance, a surface on a consumer electronic device and a hologram.

6. An apparatus, comprising:
a processor; and
a dashboard surface coupled to the processor, the processor operable to configure or reconfigure the dashboard surface for interaction with one or more users.

7. The apparatus of claim 6, wherein the dashboard surface is touch-sensitive.

8. The apparatus of claim 6, wherein the dashboard surface is from a group of dashboard surfaces consisting of: a billboard, a sign, a wall, a whiteboard, a picture frame, a glass surface, a mirror surface, one or more liquid crystal display panels, one or more light emitting diode panels, a surface on an appliance, a surface on a consumer electronic device and a hologram.

9. A method comprising:
receiving input data;
determining one or more properties based on the input; and
generating a dashboard surface having the properties.

10. The method of claim 9, further comprising:
presenting a widget on the dashboard surface, the widget including the properties.

11. A system, comprising:
a processor;
a computer-readable medium operationally coupled to the processor and configurable for storing instructions, which, when executed by the processor, causes the processor to perform operations, comprising:
receiving information from or through a dashboard surface; and
configuring or reconfiguring the dashboard surface for interaction with one or more users based on the information.

12. The system of claim 11, wherein the processor performs operations, further comprising:
presenting a widget on the dashboard surface; and
presenting content through the widget.

13. The system of claim 12, wherein the processor performs operations, further comprising:
receiving environment information associated with the environment where the dashboard surface is located; and
configuring or reconfiguring the dashboard surface based on the environment information.

14. The system of claim 12, wherein the processor performs operations, further comprising:
receiving user input; and
configuring or reconfiguring the dashboard surface based on the user input.

15. The system of claim 11, wherein the dashboard surface is from a group of dashboard surfaces consisting of: a billboard, a sign, a wall, a whiteboard, a picture frame, a glass surface, a mirror surface, one or more liquid crystal display panels, one or more light emitting diode panels, a surface on an appliance, a surface on a consumer electronic device and a hologram.

16. The system of claim 11, wherein the dashboard surface area is touch-sensitive.

17. The system of claim 11, wherein the dashboard surface information is received from a network resource.

18. The system of claim 11, wherein the dashboard surface information is received through an application programming interface (API).

19. A computer-readable medium having instructions stored thereon, which, when executed by a processor, causes the processor to perform operations, comprising:
receiving information from or through a dashboard surface; and
configuring or reconfiguring the dashboard surface for interaction with one or more users based on the information.

20. The computer-readable medium of claim 19, further comprising:
presenting a widget on the dashboard surface; and
presenting content through the widget.

21. The computer-readable medium of claim 19, further comprising:
receiving environment information associated with the environment where the dashboard surface is located; and
configuring or reconfiguring the dashboard surface based on the environment information.

22. The computer-readable medium of claim 19, further comprising:
receiving user input; and
configuring or reconfiguring the dashboard surface based on the user input.

23. The computer-readable medium of claim 19, wherein the dashboard surface is from a group of dashboard surfaces consisting of: a billboard, a sign, a wall, a whiteboard, a picture frame, a glass surface, a mirror surface, one or more liquid crystal display panels, one or more light emitting diode panels, a surface on an appliance, a surface on a consumer electronic device and a hologram.
